(19) United States
(12) Patent Application Publication
(10) Pub. No.: US 2012/0173343 A1
(43) Pub. Date: Jul. 5, 2012

(54) CONTENT MANAGEMENT SYSTEMS AND METHODS

(76) Inventor: Walter Koning, (US)

(21) Appl. No.: 13/339,348

(22) Filed: Dec. 28, 2011

Related U.S. Application Data
(60) Provisional application No. 61/427,926, filed on Dec. 29, 2010.

(51) Int. Cl. G06Q 30/02; G06F 3/01

(52) U.S. Cl. 705/14.69; 705/14.4; 715/716

(57) ABSTRACT

Methods and systems are provided for enabling users to manage content provided by content providers, the content including user-desirable content and alternate content. A computer-implemented method for altering internet advertisements comprises providing a computer system to enable an internet fast pass associated with a user having an account balance, determining if the user's account balance on the internet fast pass is above a predetermined limit, determining if the user chooses to bypass the alternate content, and disabling one or more advertisements if the user's account balance is greater than or equal to the predetermined limit.

### CROSS-REFERENCE

This application claims priority to U.S. Provisional Patent Application Ser. No. 61/427,926, filed Dec. 29, 2010, which application is entirely incorporated herein by reference.

### BACKGROUND OF THE INVENTION

Advertising is a form of communication that can persuade an audience, including viewers, readers or listeners, to purchase or take some action upon products, ideas, or services. Advertising can include the name of a product or service and how that product or service could benefit the consumer. Advertising can persuade a target market to purchase or consume a particular product or brand. Advertisements are typically paid for by sponsors and viewed via various media, such as image, sound and/or video.

Targeted advertising is a type of advertising in which advertisements are provided so as to reach consumers based on various traits, such as demographics, purchase history, or observed behavior. Interactive advertising is a method for using online or offline interactive media to communicate with consumers. Interactive advertising can promote products, brands, services, and public service announcements, corporate or political groups. Behavioral targeting is a method that uses information collected on an individual's web-browsing behavior, such as the pages they have visited or the searches they have made, to select which advertisements to display to that individual. Contextual advertising is a form of targeted advertising for advertisements appearing on websites or other media, such as content displayed in mobile browsers. Under contextual advertising, advertisements are selected and served (or presented) to a user by automated systems based on the content displayed to the user.

Content providers receive remuneration or compensation for providing advertising within the context of their content. Content providers balance a tradeoff between pursuit of advertising revenue and the experience of their audience.

### SUMMARY OF THE INVENTION

Provided herein are methods and systems for enabling a content provider (e.g., content publisher) or advertiser to be compensated in exchange for removing advertising content on an ad hoc basis. In an embodiment, a party is allowed to pay for the removal of an advertisement from display from any web site, application, or other digital medium, on a per occurrence or contractual basis.

In some embodiments, an algorithm is provided for determining the valuation of a targeted advertising space with concern for existing contracts between an advertiser and a content provider, such as, e.g., contracts for click-through fees and page view impressions will be affected if a party clicks to close an advertisement. In an embodiment, the algorithm can include a valuation with consideration for the length of time a user is exposed to an advertisement. In another embodiment, the algorithm can include elements related to an advertisement medium, the length of time an advertisement is displayed, the size and/or content of the advertisement, the location within a display or context in which the advertisement is displayed, and when (i.e., date, time, or date and time) an advertisement is displayed.

In an aspect of the invention, content management methods are provided. Content management methods provided herein can be implemented by one or more computer systems, which can include sub-systems. Content management methods provided herein can enable users to bypass or alter alternate content (e.g., advertisements) provided by alternate content providers (e.g., advertisers, advertising agencies, or proxies). Alternate content can be distributed by content publishers (e.g., web sites) along with content desired by a user.

An aspect of the invention provides a computer-implemented method for altering internet advertisements, comprising providing a computer system to enable an internet fast pass, the internet fast pass being associated with a user having an account balance; determining, with the aid of a processor or the computer system, if the user's account balance on the internet fast pass is above a predetermined limit; and disabling one or more advertisements if the user's account balance is greater than or equal to the predetermined limit. The one or more advertisements can be disabled upon command from the user provided to the computer system with the aid of a display operatively coupled to the computer system, the display having a user interface (e.g., graphical user interface). The method can be implemented or facilitated by one or more computers (“computer-implemented method”).

Another aspect of the invention provides a computer-implemented method for providing advertisements, comprising determining, with the aid of a processor, if a user's account balance on an internet fast pass is above a predetermined limit; and disabling, with the aid of a processor, one or more advertisements if the user's account balance is greater than or equal to the predetermined limit. In an embodiment, the method further comprises providing a computer system to enable the internet fast pass, the internet fast pass being associated with the user. In another embodiment, the method further comprises reducing the user's account balance by a predetermined amount upon disabling the one or more advertisements. In another embodiment, disabling the one or more advertisements comprises removing the one or more advertisements from view by the user.

Another aspect of the invention provides a method for providing advertisements, comprising providing a computer system to enable an internet fast pass, the internet fast pass being associated with a user having an account balance; determining, with the aid of a processor of the computer system, if the user's account balance on the internet fast pass greater than or equal to a predetermined limit; and altering one or more advertisements if the user's account balance is greater than or equal to the predetermined limit. The method can be a computer-implemented method—i.e., a method facilitated with the aid of a computer system having one or more processors. In an embodiment, altering the one or more advertisements comprises removing the one or more advertisements from view by the user. In another embodiment, altering the one or more advertisements comprises providing one or more advertisements that are different from the one or more advertisements. In another embodiment, altering the one or more advertisements comprises providing advertisements in accordance with advertisement matching criteria associated with the user. In another embodiment, the advertisement matching criteria includes the user's likes and interests. In another embodiment, altering the one or more advertisements comprises disabling the one or more advertisements. In another embodiment, disabling the one or more advertisements comprises transforming an advertisement layer on the user's computer screen to remove the one or more advertisements from view by the user.

Another aspect of the invention provides a computer-implemented method for altering content presented to a user, comprising calculating, with the aid of a processor, the value of a first content to a user, the first content selected in accordance with criteria provided by the user; presenting the first content to the user in place of the second content; and collecting an item of value to the user to be presented with the first content, the item of value of equal or greater value than the calculated value of the first content. In another embodiment, calculating the value of the first content to the user comprises using a computer system to calculate a user-valued estimation of the first content. In another embodiment, the content presented to the user includes web content. In another embodiment, the content presented to the user includes video content. In another embodiment, the content presented to the user includes audio content. In another embodiment, the content presented to the user includes one or more of text, image, video and audio. In another embodiment, the value of the first content is calculated based on the value to the user for not presenting the user with the second content.

Another aspect of the invention provides a computer-implemented method for altering content presented to a user, comprising providing a system for presenting a first content and second content to a user, the second content less desirable to the user than the first content; calculating, with the aid of a processor of the system, the value to the user for not presenting the second content to the user; and presenting the first content to the user in place of the second content. In an embodiment, the method further comprises collecting an item of value to the user to be presented with the first content. In another embodiment, the item of value to the user is equal in value to the calculated value to the user for not presenting the second content to the user.

Another aspect of the invention provides a computer-implemented method for providing content to a user, comprising presenting a user with a first content that is more desirable to the user than a second content; and collecting, with the aid of a processor, an item of value to the user to be presented with the first content, the item of value having a value that is greater than, equal to or less than a calculated value to the user for not presenting the second content to the user. In an embodiment, the calculated value is determined by the time of day. In some case, the calculated value can vary based on the time of day the value is calculated. In another embodiment, the calculated value is determined by the length of time the second content will not be presented. In another embodiment, the calculated value is determined by the digital medium of the second content. In another embodiment, the calculated value is determined by a negotiated value between parties involved. In another embodiment, the calculated value is determined by an algorithm. The algorithm can be provided by way of machine-executable code stored in a memory location of a system having the processor. In another embodiment, the calculated value is determined by properties of the first content. In another embodiment, the calculated value is determined by characteristics specific to the user. In another embodiment, the calculated value is determined by the size of the second content. In another embodiment, the calculated value is determined by the frequency of the second content. In another embodiment, the calculated value is determined by the number of times the alternate content has been previously displayed. In another embodiment, the calculated value is determined by the number of times the alternate content has been previously altered. In another embodiment, the calculated value is determined by the number of times the alternate content has been previously shared. In another embodiment, the calculated value is determined by the number of times the alternate content has been previously shared on a social networking site.

Another aspect of the invention provides a computer-implemented method for providing content to a user, comprising presenting a user with a first content that is more desirable to the user than a second content; and collecting, with the aid of a processor, an item of value to the user to be presented with the first content, the item of value having a value that is greater than or equal to a calculated value to the user for not presenting the second content to the user. In some cases, the item of value has a value that is equal to a calculated value to the user for not presenting the second content to the user.

Another aspect of the invention provides a computer-implemented method for determining the desirability of advertising material to a user, comprising enabling, with the aid of a processor, a user to bypass alternate content having advertising material to view original content having user-desirable material; determining, with the aid of a processor, whether the user has bypassed the alternate content; and building the user's viewing preferences. The viewing preferences can be located on a memory location of a computer system implementing the method. In an embodiment, building the user's viewing preferences comprises enabling the user to bypass alternate content a plurality of times. In another embodiment, determining whether the user has bypassed the alternate content comprises determining whether the user has withdrawn money from a bypass account associated with the user. In another embodiment, determining whether the user has bypassed the alternate content comprises determining whether the user has shared the alternate content.

Another aspect of the invention provides content management systems for enabling users to manage content. Content management systems provided herein can enable users to bypass or alter alternate content. Content management systems provided herein can provide users with an internet fast pass, which can enable users to bypass or alter alternate content. Content management systems provided herein can include, or be associated with, other systems and sub-systems for facilitating content management to users.

Another aspect of the invention provides a system for providing an internet fast pass, comprising a sub-system to enable a user to deposit money in an internet fast pass, the internet fast pass for enabling the user to bypass one or more advertisements on a web site. The sub-system communicates with one or more external web site providers to enable the user to bypass one or more advertisements if the user's fast pass balance is at or above a predetermined limit.

Another aspect of the invention provides a content management system, comprising a first sub-system to enable a user to bypass alternate content to view content desirable to the user; and a second sub-system for collecting user bypass and viewing statistics. The first sub-system communicates with a content publisher to enable the user to bypass alternate content if the user provides the content publisher an item of value meeting a valuation of the alternate content.

Methods provided herein can be facilitated with the aid of computer systems having one or more processors for executing machine-executable code implementing methods provided herein. The machine-executable code can be stored on one or more memory locations of such computer systems.

### INCORPORATION BY REFERENCE

All publications, patents, and patent applications mentioned in this specification are herein incorporated by reference to the same extent as if each individual publication, patent, or patent reference was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A schematically illustrates a system for managing content, in accordance with an embodiment of the invention. FIG. 1B schematically illustrates a content management system of FIG. 1A, in accordance with an embodiment of the invention;

FIG. 2 illustrates a method for altering one or more advertisements, in accordance with an embodiment of the invention;

FIG. 3 illustrates a flow diagram (or workflow) for providing alternate content and original content to a user, in accordance with an embodiment of the invention; and

FIGS. 4A-4C illustrate flow diagrams for valuing content to users, in accordance with various embodiments of the invention.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein can be employed in practicing the invention.

Definitions of terms provided herein are intended to be illustrative and not limiting. Other definitions of terms and usages of such terms can occur to those skilled in the art.

The term “content provider,” as used herein, includes a user or entity that has or otherwise operates one or more systems for providing content to users. A content provider in some cases is a content publisher. In an example, a content provider is a web site or an entity administering the web site that may have discretion as to the content provided on the web site.

The term “financial account,” as used herein, includes an account with the ability to store something of value to a user (also “value item” herein). A user can add more value, apply value, and remove the value from the account. For example, a financial account can include an account holding a monetary value, virtual currency, or anything of value to the user.

The terms “desired content” and “original content,” as used herein, include any content a user desires (or chooses) to view, hear, or view and hear. For example, desired content can include video on a web site (e.g., YouTube®, Vimeo®, Google® videos, news websites, blogs, journalism websites), such as a digital video on a digital video recorder, on-demand digital content, an audio player, a digital radio station, or digital audio on the Internet. In an embodiment, desired content can be user-desirable content—i.e., content desirable to, or desired by, one or more users.

The term “alternate content,” as used herein, can include content a user does not choose to see or experience. For example, alternate content can include a graphic (e.g., an image), animation, video or audio advertisement (also “ad” herein).

The term “valuation,” as used herein, refers to an estimation of the value or worth of certain content (e.g., desired content, alternate content) to one or more users. In an embodiment, valuation can include an estimation of the value to a user for not presenting the user with certain content, such as the value to a user for not presenting the user with alternate content. In another embodiment, valuation can include an estimation of the value to a user for presenting the user with certain content, such as the value to a user for presenting the user with desired content.

The term “user,” as used herein, includes any individual who may experience content, including desired content and alternate content. In an embodiment, a user is a consumer, such as a product or service consumer. In another embodiment, a user is a web user. In another embodiment, a user is a user of a mobile device. In another embodiment, a user is a television viewer. In another embodiment, a user is any individual or entity that is presented or provided with the opportunity to view content, including desired content and alternate content.

The term “impression,” as used herein, refers to a single exposure of a user to content, such as, for example, a web site, web page, or advertisement. An impression can refer to a single view of an advertisement. In some cases, advertisers can pay for an impression on a cost per mille (CPM) or cost per thousand (CPT) basis. The term “per mille”, as used herein, can refer to a thousand impressions, or loads, of an advertisement. In some cases, some impressions, such as reloads or internal user action, can be excluded from counting. In some cases, display of a video advertisement may count as an impression when it is served. In some cases, display of a video advertisement may count as an impression when the video is played to completion.

Current content providers (e.g., content publishers), such as web sites, can provide users with various advertisements (also “ads” herein), such as sports ads, consumer products ads, and media ads. In at least certain cases, users do not have control over the types of ads they are presented or whether they can even avoid being presented with ads entirely. There are advertisement-blocking software programs or utilities that can enable users to disable web site-based advertisement, but such software might not be able to remove embedded advertisements.

While there are advertisement-blocking software programs or utilities currently available, such programs or utilities, notwithstanding their drawbacks, provide some benefit to some users but at the expense of content publishers, including advertisers, marketing firms and companies that spend considerable money in disseminating such ads.

Methods and systems provided herein can enable content publishers, such as web sites, to alter advertisements based on predetermined criteria, such as the value of the advertisements to users and entities (e.g., companies) associated with such advertisements. In an embodiment, a method is provided for avoiding content provided by a content publisher in exchange for an item of value or benefit to a user, such as money, for viewing desirable content in exchange for less desirable content.

In some embodiments, methods and systems are provided for collecting an item of value, such as money, from a user in exchange for providing content desirable to the user, such as media content (e.g., internet-based media content). In an embodiment, desirable content can include one or more altered advertisements, such as advertisements altered in view of a user's preferences (e.g., sports ads in place of randomly-generated ads). In another embodiment, advertisements are altered by a system (e.g., computer system) by removing the advertisements from view by the user.

In an embodiment, in the course of browsing content provided by a content publisher, such as an internet web site, a user (also “content consumer” herein) can navigate to content provided by the content publisher. The content publisher can provide the content to the content consumer without one or more advertisements in exchange for an item of value or benefit to the content consumer, such as money or credit. In some cases, the content publisher can provide alternate content prior to providing the content the content consumer intends to view. For example, the content publisher can provide web content (including media) without certain advertisements, or provide content with altered advertisements (e.g., targeted advertisements). In another embodiment, if the content publisher provides alternate content, the content consumer is subject to the alternate content until an event occurs, as decided by the content publisher. Such an event can include obtaining a value item or value object, such as an object of value or benefit to the content consumer (e.g., money, or credits).

In some embodiments, the value item can be provided by a system in communication with the content publisher. The system can transfer the value item (or an equivalent of the value item) to the content publisher. In an embodiment, the system can be a system for enabling the content consumer to deposit money. In another embodiment, the system can be a system for providing the content consumer a line of credit. In another embodiment, the system can be an internet fast pass system.

In some embodiments, systems and methods are provided for bypassing alternate content to present a user with desired content, the value to the user for bypassing the alternate content being determined by one or more valuation methods. In other embodiments, systems and methods are provided for bypassing alternate content to present a user with desired content, the value to the user for being presented with the desired content being determined by one or more valuation methods.

### Content Management Systems

In an aspect of the invention, content management systems are provided for enabling users to manage content provided to the users. In some embodiments, a financial account system is provided to allow a user to bypass alternate content provided by a content publisher. Alternate content can include one or more advertisements. In some cases, a user can bypass an advertisement.

In some embodiments, a system is provided for providing a value to the alternate content. The user can bypass the alternate content by providing an item of value to the user, such as money, to a system providing the alternate content.

In an embodiment, the content management system can collect user usage data, such as user behavior. For example, the content management system can collect information with respect to the types of ads a user bypasses and the types of ads the user does not bypass. The system can provide such information to advertisers and marketing firms, which can use the information to provide users with the types of ads the users prefer. In such a case, the content management system can advantageously increase the return to advertisers and marketing firms on their investments.

In an embodiment, a user bypasses alternate content to view original content by providing an item of value to the user to a system hosting the original content. In an embodiment, the system values the alternate content at a value that is deducted from the user's account to view the original content. In some embodiments, alternate content is associated with a first value, and a user bypasses or terminates viewing the alternate content to view the original content for a second value that is provided by the user. In an embodiment, the second value is equal to the first value. In another embodiment, the second value is estimated on a per-use basis, such as each time a user desires to bypass the alternate content to view the original content. Such per-use basis can vary with the time of day a user desires to view the original content, or the frequency at which users desire to view the original content.

In various embodiments, the desirability of content to a user can be assessed by the system based on various factors, such as one or more of a user's viewing history, a user's preferences (such as preferences provided in a profile of the user on the system), the user's viewing pattern (i.e., viewing certain content and bypassing other content), the length of time a user spends experiencing alternate content before bypassing the alternate content, the value paid by a user to bypass alternate content of similar nature, the number of times alternate content of like or similar nature has been displayed, the number of times alternate content of like or similar nature has been bypassed, and the number of times alternate content of like or similar nature has been shared (e.g., on a social networking site, such as, for example, Facebook, Linkedin, Myspace, Google+ or Twitter).

In some embodiments, an advertisement management system is provided that can enable a user, upon visiting a web site, to view certain types of advertisement, certain advertisements, or to view no advertisements. In an embodiment, a system for enabling a user to control advertisement content is provided. In an embodiment, the system can provide an internet fast pass (or “ad bypass”) to a user. In an embodiment, such a fast pass can enable a user to navigate the internet without being presented with advertisements. In another embodiment, a fast pass can enable a user to choose to be presented with certain ads (e.g., Apple® advertisements, Microsoft® advertisements), or types of ads (e.g., consumer advertisements, sports advertisements). In another embodiment, the system can enable a user to select the one or more advertisements the user wishes to view. In another embodiment, the system can enable a user to choose not to view any advertisement. In another embodiment, the system can enable a user to select the one or more types of advertisements (e.g., sports advertisement, consumer products advertisements) the user wishes to be presented with.

In an embodiment, the advertisement management system (also “system” herein) provides a user with a user account in which the user can specify the user's preferences (e.g., no advertisements from company 1, no sports advertisements). The system can enable the user to deposit money in the user's account, thereby creating a user balance. In an embodiment, the money deposited by the user can be referred to as “internet advertising cash”. In another embodiment, the money deposited by the user can be referred to as “iCash”. In another embodiment, the money deposited by the user can be referred to as “Fast Cash”. In another embodiment, the money deposited by the user can be referred to as “credits”. Such terms can be used synonymously, but in some cases they can be used differently in certain contexts. For example, iCash might be an appropriate term to use in the context of Apple® iAd.

In an embodiment, a user visits a web site having advertising material (also “advertisement” herein). The system communicates with the web site to determine if certain advertising material is capable of being removed, and whether the user wishes such material to be removed. If the user desires that such advertising material not be displayed on the web site, and if the web site will permit such advertising material to be removed, the system will provide the web site (or a system or sub-system in communication with the advertisement management system) a request that the advertising material (or a subset of the advertising material) be removed. The system then provides the web site money from the user's account for the removal request—i.e., money is provided to the web site (or system or sub-system communicating with the advertisement management system) and money is withdrawn from the user's account. The balance on the user's account is decreased upon the transaction. The user can then navigate the web site with limited or no ads, based on the user's preferences.

In an embodiment, the system enables the user to control the type of advertisement material presented to the user while deducting money from the user's account. In an embodiment, the money deducted can be a fixed amount—that is, the system will deduct a fixed amount for each web site visited by the user, or a fixed amount each time the user launches his or her web browser (or other internet access program). In another embodiment, the money deducted can be an amount that is related to the web site the user has navigated to. In such a case, certain web sites might require more money be provided by the system (on the user's behalf) to remove some or all of advertisement content from the web site. The system can then present the user with the user's balance.

In an embodiment, video advertisers embed a video ad into video content, and a user can remove or bypass those ads by clicking on a link to skip the ad. By clicking the link, the web site hosting the video will contact the advertisement management system and request that certain money be transferred to a system or sub-system of the web site that is responsible for such a transaction (collectively referred to as “web site's system”). If the user's account has sufficient funds, the advertisement management system will transfer money to the web site's system. The user's account balance will be decreased in view of the transaction. The user will then be able to view the video embedded in the web site without any ads. In an embodiment, the user can view the video with certain user-selected ads or types of ads. In such a case, the web site would assess a smaller fee to provide the user with such user-selected ads or types of ads.

In an embodiment, a user can have their account auto-refill by connecting a credit card, bank account, PayPal account, or other source of funds to the user's account. A content publisher can determine the amount the ad is worth and indicate how much will be deducted (e.g., $0.10 to bypass this ad). A report of ads bypassed can be made available for the user in the user's account. In addition, the user's balance can be made available for the user in the user's account.

In an embodiment, the user's web browser can be configured to include a program or utility at a user-defined location of the user's web browser, the program or utility configured to communicate with the advertisement management system to provide information relating to the user's account, such as account balance. As such, as the user navigates the internet from one web site to another, the user will have ready access to the user's account, including account balance and status (e.g., “$5.00 left in account”, “Internet Fast Pass disabled”).

In an embodiment, the content publisher can embed a program or utility within the content management system, the program or utility configured to communicate with the advertisement management system to provide information relating to the user's account, such as account balance. As such, as the user navigates the Internet from one web site to another, the user can have ready access to the user's account, including account balance and status (e.g., “$5.00 left in account”, “Internet Fast Pass disabled”).

In an embodiment, the advertiser can embed a program or utility within the alternate content, the program or utility configured to communicate with the advertisement management system to provide information relating to the user's account, such as account balance. As such, as the user navigates the Internet from one web site to another, the user will have ready access to the user's account, including account balance and status (e.g., “$5.00 left in account”, “Internet Fast Pass disabled”).

In an embodiment, the advertisement management system is configured to gather data analytics. Such analytics can be of interest to marketing firms and companies interested in targeting their advertising material to a subset of users (e.g., toy advertisements to children, sport advertisements to sports enthusiasts).

In an embodiment, the advertisement management system can help implement a market for the valuation of time, including the time a user spends watching one or more advertisements at a particular web site and the time the user spends viewing other content on the web site. Such a market can be used to determine a value for alternate content and provide the user the ability to remove the alternate content by providing an item of equal or greater value than the value of the alternate content.

In another aspect of the invention, a system for managing content comprises a content publisher and a content management system, the content publisher configured to communicate with the content management system. The content management system can include a financial account system configured to provide an item of value to the user (e.g., money). The content publisher includes user-desired content (i.e., content desirable to the user) and alternate content, such as advertisements (“ads”). The content publisher is configured to communicate with the content management system to determine content selection criteria, such as the user's content-viewing preferences, the frequency at which the user views certain content, the frequency at which the user elects to bypass certain alternate content, the value of the desirable content to the user or market and the value for not being presented with the alternate content to the user or market.

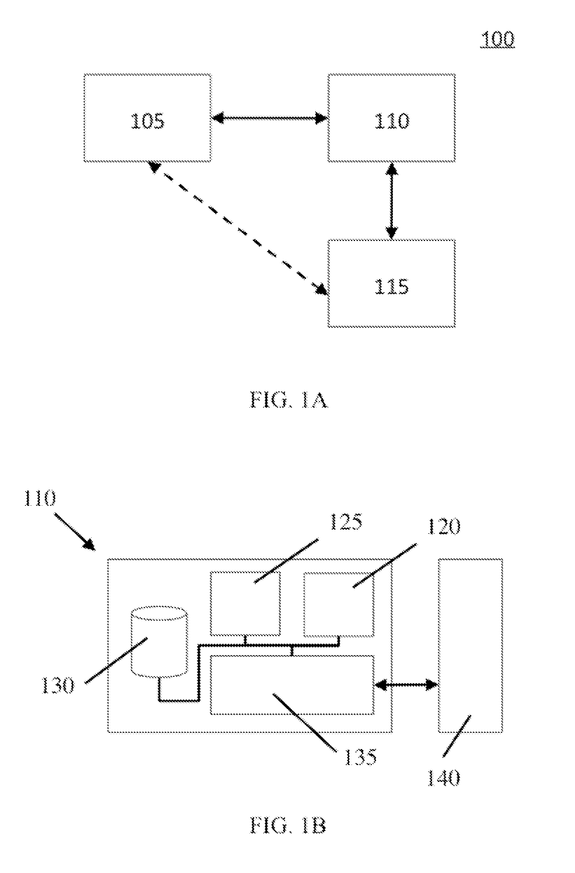

With reference to FIG. 1A, a system 100 for managing content is provided, in accordance with an embodiment of the invention. The system 100 includes a content publisher 105 (e.g., web site) that is configured to communicate with a content management system 110. The content management system is configured to communicate with a financial account system 115. The financial account system 115 can include an item of value to a user to the content management system 110, which can be provided to the content publisher in exchange for enabling the user to bypass alternate content or view user-desirable alternate content. In an alternative embodiment, the financial account system 115 can communicate directly with the content publisher 105 (as indicated by the dashed line).

With continued reference to FIG. 1A, the content publisher 105 and content management system 110 can be part of the same system or different systems. In an embodiment, the content publisher 105 is a different system than the content management system 110. The content publisher 105 can be located at a first geographic location and the content management system 110 can be located at a second geographic location different from the first geographic location. In another embodiment, the financial account system 115 is a different system than the content management system 110. The financial account system 115 can be located at a third geographic location and the content management system 110 can be located at a second geographic location different from the third geographic location.

Methods provided herein can require providing services to one or more users, content publishers and/or alternate content providers in a relatively short period of time, such as within microseconds, or milliseconds, or seconds, or minutes. Methods provided herein can thus require a tremendous amount of processing capability, making them extremely difficult, if not impossible to perform, without the aid of one or more computer systems or sub-systems configured to operate at processing speeds of at least about 0.001 millions of instructions per second (“MIPS”), or 0.01 MIPS, or 0.1 MIPS, or 1 MIPS, or 10 MIPS, or 20 MIPS, or 30 MIPS, or 40 MIPS, or 50 MIPS, or 60 MIPS, or 70 MIPS, or 80 MIPS, or 90 MIPS, or 100 MIPS, or 500 MIPS, or 1000 MIPS, or 10,000 MIPS, or 100,000 MIPS, or 1,000,000 MIPS. Systems provided herein are configured to interact with content publishers and alternate content providers to provide services at various levels of user demand.

With continued reference to FIG. 1A, the content publisher 105, the content management system 110 and the financial account system 115 can each include hardware and software, such as an operating system (e.g., Apple® Mac OS, Microsoft® Windows®, Linux, Chromium, Debian, Ubuntu), a central processing unit (CPU), random-access memory (RAM), read-only memory (ROM), flash memory, cache, hard drive, in addition to one or more databases for storing information. The content publisher 105, content management system 110 and financial account system 115 can include modules and/or subsystems. In an embodiment, the financial account system 115 is a subsystem in the content management system 110. In another embodiment, the content publisher 105, content management system 110 and financial account system 115 are subsystems in a larger system for providing content to one or more users.

With reference to FIG. 1B, the content management system 110 includes a CPU 120, memory (e.g., RAM, ROM, flash memory) 125, physical storage media 130, and a communications module 135. The CPU 120, memory 125, physical storage media 130 and communications module 135 can be linked to one another. The physical storage media 130 can include any non-volatile data storage medium, such as one or more hard disks, tape drives, optical drive, and combinations thereof. The physical storage media 130 can store a profile of a user. In an embodiment, the content management system 110 can enable a user to add a profile, edit the profile and remove the profile. In another embodiment, the communications module 135 is configured to permit the content management system 110 to communicate with other systems or sub-systems 140, such as the content publisher 105 and financial accounting system 115. The communications module 135 can include any interface for permitting the content management system 110 to communicate with other systems. In an embodiment, the communications module 135 includes an interface for communicating with a local area network (“LAN”), such as a wired or wireless network interface.

In some embodiments, the content management system 110 can provide an interface to enable a user to modify the user's profile and preferences, and to add money (or other item of value) to an account associated with the user. In an embodiment, the interface is a graphical user interface (GUI). In another embodiment, the interface is a web interface. In another embodiment, the interface is an application, such as a Java-enabled application. In another embodiment, the interface is an application for operating on an electronic device. Such an application can be associated with a sub-system operating on the electronic device. In another embodiment, the interface is an application for operating on a portable electronic device, such as a smart phone, slate or tablet personal computer (PC). For example, the interface can be an application (“app”) for operating on an Apple® iPhone®, Apple® iPad®, Apple® iPod®, an Android-enabled portable electronic device (e.g., Droid), a Blackberry® device, an HTC device, or a Windows® phone. Such apps can be associated with sub-systems operating on electronic devices, such as, for example, a sub-system operating on a portable electronic device.

### Content Management Methods

In another aspect of the invention, computer-implemented methods for altering content presented to a user are provided, comprising providing a system for presenting a first content and second content to a user, the second content less desirable to the user. The first content can be selected in accordance with criteria provided by the user. Next, the value to the user for not presenting the user with the second content is calculated. The value for not presenting the user with the second content can be based on the user-specific criteria, such as the frequency at which the user views the second content and the user's profile and viewing preferences. In an embodiment, the value is calculated based on the value of the first content to the user. Next, the first content is presented to the user in place of the second content, and an item of value to the user is collected from the user (or a financial account associated with the user) to be presented with the first content. In an embodiment, the item of value can be of equal value than the calculated value for the user to not be presented with the second content. In another embodiment, the item of value can be of equal value than the calculated value of the first content to the user. In another embodiment, the item of value can be of greater or lesser value than the calculated value of the alternate content provided to the user.

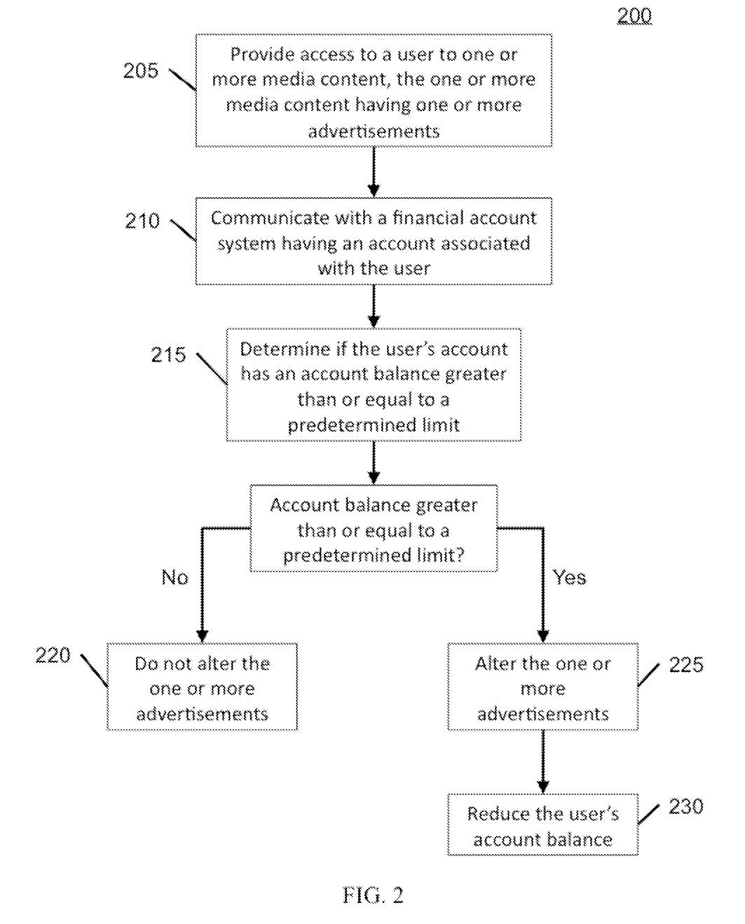

With reference to FIG. 2, a method 200 for altering one or more advertisements is provided, in accordance with an embodiment of the invention. In a first step 205, a system provides access to a user to one or more media content having one or more advertisements. The one or more media content can include one or more of text, image, video and audio material. Next, in a second step 210, the system communicates with a financial account system having an account associated with the user. Such a system can be an internet fast pass system.

Next, in a third step 215, the system determines if the user's account has an account balance greater than or equal to a predetermined limit. In an embodiment, the system determines if the user's account balance is greater than a predetermined limit. In another embodiment, the predetermined limit can be a user-valued (i.e., valued by the user) or market-valued (i.e., valued by a market for advertisements equal or similar to the one or more advertisements) estimation of the one or more advertisements. In another embodiment, the predetermined limit can be a user-valued (i.e., valued by the user) or market-valued (i.e., valued by a market for advertisements equal or similar to the one or more advertisements) estimation for not presenting the user with alternate content, such as one or more advertisements (“ads”).

With continued reference to FIG. 2, in step 220, if the account balance is not greater than or equal to a predetermined limit, the system does not alter the one or more advertisements. If the account balance is greater than or equal to a predetermined limit, in step 225, the system alters the one or more advertisements. In an embodiment, the system can remove the one or more advertisements from the user's view. In another embodiment, the system can present the user with one or more advertisements that are more desirable to the user, such as one or more advertisements selected in accordance with a user's profile provided on the financial account system.

Next, in step 230, the system can retrieve an item of value (or benefit) to the user. In an embodiment, the system collects the item of value from the financial account system. In another embodiment, the item of value can have a value that is equal to the predetermined limit. In another embodiment, the item of value can have a value that is less than the predetermined limit. In another embodiment, the item of value can have a value that is a user-valued estimation for not viewing the one or more advertisements. In another embodiment, the item of value can have a value that is a market-valued estimation for not viewing the one or more advertisements.

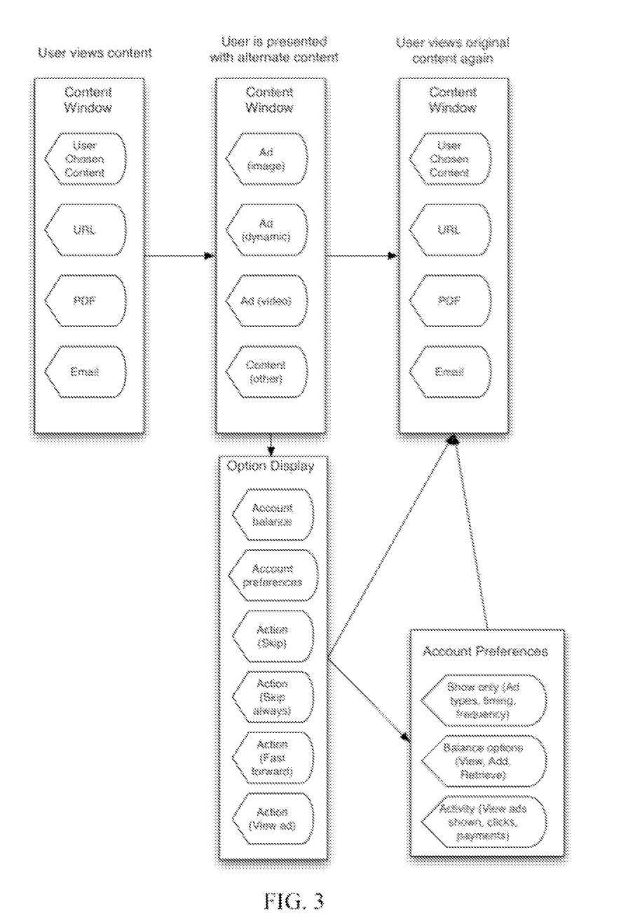

With reference to FIG. 3, a flow diagram for providing alternate content and original content (or “user chosen content”) to a user is illustrated, in accordance with an embodiment of the invention. In the illustrated embodiment, a content publisher provides original content (or desired content) and alternate content. In an embodiment, the alternate content is provided before a user can view the original content. The alternate content can include an advertisement (also “ad” herein), which can include, for example, images, dynamic content (e.g., Adobe Flash® ads), video content, audio content, and video and audio content. In an embodiment, the user can view the desired content and bypass (e.g., terminate viewing) the alternate content by providing an item of value to the user (e.g., money) from a financial account, such as a system for providing the item of value. In an embodiment, such a system can calculate a value for not being presented with the alternate content. In another embodiment, such a system can calculate a value for providing different or more desirable content in place of the alternate content. In an embodiment, the value for not being presented with the alternate content can be based on its value to the user (i.e., user-valued estimation). In another embodiment, the value for not being presented with the alternate content can be based on its value to the market (i.e., market-valued estimation), for example. Upon providing an item of value to the content publisher, the system provides the desired content to the user and removes the alternate content. The desired content can include user-chosen content, such as one or more of text, image, video, audio, uniform resource locator (“URL”), PDF and email.

With continued reference to FIG. 3, a content publisher displays original content and alternate content. A user can access and manage a financial account for bypassing the alternate content to view the original content. The financial account can be provided by a system for enabling the user to manage the manner in which the user views desired content and alternate content. Such a system can include a profile associated with the user, the profile including the user's likes and preferences and the type of alternate content the user desires to view. In an embodiment, the financial account can provide an internet fast pass, enabling the user to bypass all advertisements (“ads”) or certain ads less desirable to the user. The user's profile can further allow the user to indicate the frequency at which the user views ads, the user's account balance, and the user's activity.

In some embodiments, the system for providing the financial account can collect and make available user activity information to enable other systems to value alternate content. In an embodiment, the system is an internet fast pass system for permitting a user to selectively view alternate content, such as ads, or to bypass ads altogether for a set fee provided by the user at predetermined intervals. In another embodiment, the user can elect to bypass all internet ads by providing the financial account system a predetermined fee on an hourly, daily, weekly, monthly, yearly, or lifetime basis. For example, the user can pay $12.95 per month to bypass all ads.

### Valuation Methods

In another aspect of the invention, content valuation methods are provided. Content valuation methods provided herein can enable users, content providers (e.g., content publishers) and providers of alternate content (e.g., advertisers) to determine one or more values of alternate content to a user (e.g., a consumer of the content), the value of original content to the user, the value of presenting the original content to the user and the value of not presenting the alternate content to a user.

In some embodiments, a user deposits money in a content management system or financial account system associated with the content management system, the money for use in enabling the user to bypass alternate content provided by an alternate content provider (e.g., advertiser). In an embodiment, such money can be provided by way of electronic funds, currency or any real property of value to the user. In another embodiment, the content management system can provide money from the user with the aid of a line of credit (e.g., Visa®, MasterCard®), a debit account (e.g., Bank of America® debit, PayPal®), or any other electronic fund, such as Facebook credits, for example.

In an embodiment, the content management system enables alternate content providers to pay content publishers the realized value (or value of the alternate content upon a user bypassing the alternate content) of alternate content. In another embodiment, the content management system enables content publishers to receive the difference (“alternate content value difference”) between the full value of alternate content and the realized value of the alternate content. In another embodiment, the content management system retains a portion of the alternate content value difference and provides the content publisher the remainder.

In an embodiment, with the aid of a content management system, the user bypasses alternate content to view original content, the bypassed alternate content having a predetermined value—e.g., a bypassed value that is less than a value of the alternate content had the user watched the entirety of the alternate content. The content management system provides a provider of the alternate content the predetermined value of the bypassed alternate content. If the value is less than a full value of the alternate content to the alternate content provider, the content management system will provide the difference in value to the content publisher. A portion of the money from the user can be retained by the content management system.

In an embodiment, the value of bypassed alternate content is a function of (or dependent on) the length of time a user experiences (e.g., views, listens to, watches) the alternate content without bypassing the alternate content. For example, if the value of alternate content, as determined by one or both of a content publisher and alternate content provider, is $5, and a user bypasses 10% of the alternate content, the value of experienced alternate content is 90% of $5, or $4.50. In such a case, the alternate content provider can provide the content publisher the value of the experienced alternate content. The content management system can calculate the amount owed to the content publisher and provide that amount to the content publisher. For example, if the bypassed value of alternate content is $0.50 and the value of the alternate content is $5, the content management system can provide the difference between $5 and $4.50, or $0.50 (“alternate content value difference”), to the content publisher. In some cases, the content management system can retain at least a portion of the alternate content value difference. For example, the content management system can retain $0.25 of the alternate content value difference. The difference can be retained for the content management system facilitating the transaction.

In an embodiment, the value of content (e.g., desired content, alternate content) is dependent on one or more of the placement of content, the type of content, material provided in the content, the size of the content, the available volume (or supply) of the content, the demand of the content, user history (e.g., viewing statistics) associated with the content, the number of views associated with the content, the number of bypasses of the content, the length of time a user or a plurality of users view the content, the number of saves of the content to a user-desirable category associated with a user's profile, the length of the content, the time of day the content is viewed or provided to a user, the urgency in which a user requires the content, the originality of the content, the re-occurrence of the content, a user's demographics, a user's preferences, a user's viewing behavior (e.g., click-through operations), a user's viewing history, a user's bypasses, and a user's saves to a user-desirable module in the user's profile. In another embodiment, the value of content is dependent on one or more of pre-existing contracts between a content publisher and alternate content provider, future contracts between a content publisher and alternate content provider and new contracts between a content publisher and alternate content provider, including one or more of the type of contact, the value of the contract, the length of time for performance under the contract.

In an embodiment, the value of bypassed alternate content is a fraction of the value of un-bypassed (or fully-viewed) alternate content. In another embodiment, the value of bypassed alternate content is a function of the length of time, with respect to the full length of the alternate content, a user views the alternate content.

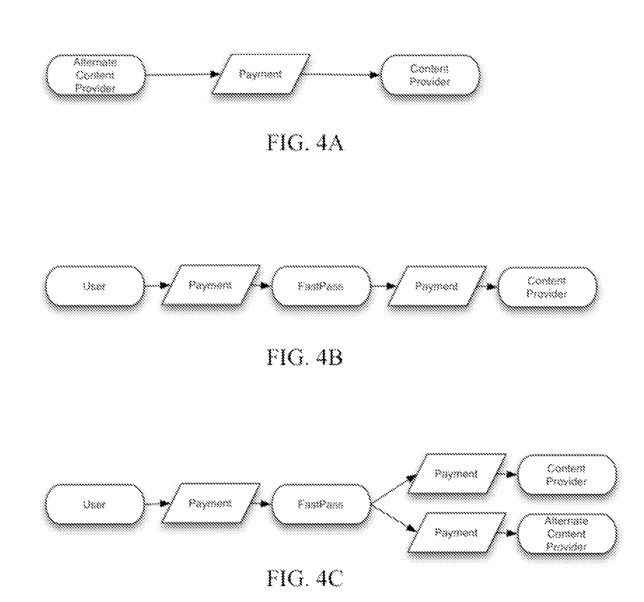

FIGS. 4A-4C illustrate various approaches for facilitating a transaction between an alternate content provider (e.g., an advertiser) and a content publisher (e.g., a web site that will display an ad of an advertiser), in accordance with various embodiments of the invention.

With reference to FIG. 4A, an alternate content provider provides a payment directly to a content publisher, in accordance with an embodiment of the invention. The payment is to enable the content publisher to provide alternate content (e.g., an advertisement) provided by the alternate content publisher for display to one or more users.

With reference to FIG. 4B, a content management system makes a payment to a content publisher, in accordance with an embodiment of the invention. First, a user makes a payment into a Fast Pass (also “FastPass” herein) account associated with the user, the Fast Pass account provided by, or associated with, the content management system, such as any content management system provided herein. The content management system subsequently makes a payment from the user's Fast Pass account to the content publisher. The payment is to enable the user to bypass certain alternate content.

With reference to FIG. 4C, a content management system makes a payment to a content publisher and alternate content provider, in accordance with an embodiment of the invention. First, a user makes a payment into a Fast Pass account associated with the user, the Fast Pass account provided by, or associated with, the content management system, such as any content management system provided herein. Next, the content management system makes a payment from the user's Fast Pass account to one or more of the content publisher (e.g., web site) and alternate content provider (e.g., advertiser). The payment is to enable the user to bypass certain alternate content.

### EXAMPLES

The examples below are intended to be illustrative and non-limiting.

### Example 1

While browsing the Internet, a user navigates to a web page with a first video clip that the user desires to view. The content is provided by a web site having the web page. Before the web site provides the user the first video clip, the web site provides the user a second video clip having, for example, an advertisement. Users must typically wait until the second video clip ends before watching the first video clip. The user elects to bypass the second video clip by using an internet fast pass having an account balance. A system for providing the internet fast pass transfers money to a system providing the video clip (or a system associated with the web site providing the video clip). The user then watches the first video clip without viewing the second video clip.

### Example 2

While browsing the internet, a user navigates to a web page having content the user desires to view (“original content”). A display with a still image or text appears over the original content (also “desired content” herein). In order to view the original content and skip (or stop) viewing the still image or text, the user clicks on a button to make the display go away. Alternatively, under a fast pass-viewing mode, the system automatically removes the still image or text to provide the desired content without any input from the user. A value item is transferred to the web site to enable the user to view the original content without having to view the still image or text.

### Example 3

While browsing the internet, a user navigates to a web page having original content. A display with an animated image appears over the original content. In order to view the original content, the user clicks on a button to make the display go away.

### Example 4

While browsing the internet, a user navigates to a web page with an advertisement displayed on the side of the page. The user desires to remove the advertisement from view. The user clicks on a button (e.g., “Remove Advertisement”) to make the advertisement go away in exchange for an item of value to the user. In an embodiment, upon removing (or disabling) the advertisement from view, the advertisement is not presented to the user upon the user returning to the web page.

### Example 5

While browsing the internet, a user navigates to a web page with any form of content. An audio file begins to play. In order to stop the clip or bypass the clip, the web page presents the user with the option to bypass or stop the clip (e.g., “Click here to stop or bypass the clip”). The user elects the option, and an item of value is provided by the user (or a system associated with the user) to a system that provides (or hosts) the web page.

### Example 6

A user visits a web site to view content desired by the user (“desired content”). A system hosting the web site presents the user with alternate content (e.g., ads) before the desired content. The system determines that the value of the desired content to the user is $5 per visit. The system provides the user with the option to bypass the alternate content immediately and view the desired content. The user elects the option. The system collects $5 from the user or a financial account associated with the user and presents the desired content to the user.

### Example 7

A user visits a web site to view content desired by the user (“desired content”). A system hosting the web site presents the user with alternate content (e.g., ads) before the desired content. The system determines that the value to the user for not viewing the alternate content is $0.05 per visit. The system provides the user with the option to bypass the alternate content immediately and view the desired content. The user elects the option. The system collects $0.05 from the user or a financial account associated with the user and presents the desired content to the user.

### Example 8

A user visits a web site to view content desired by the user (“desired content”) or desirable to the user (“desirable content”). A system hosting the web site presents the user with alternate content (e.g., ads) before the desired content. The system determines that the user has an internet fast pass, which enables the user to skip all alternate content on the system. The system immediately presents the desired content to the user.

### Example 9

A user uses a digital application to view content desired by the user (“desired content”). A system hosting the application presents the user with alternate content (e.g., ads) at the same time as desired content. The system offers a means for the user to bypass the ads (e.g., a graphical image and an option to “click”). The user is identified by the system and offers to bypass the ad for a value to be determined on a case-by-case basis.

### Example 10

A user plays content on a digital media player and is presented content desired by the user (“desired content”). A system hosting the media presents the user with alternate content (e.g., ads) before the desired content. The user is able to select an option to bypass the ads in exchange for a specified value deducted from their available balance.

### Example 11

A user answers a phone call and is presented content desired by the user (“desired content”). A system hosting the phone call presents the user with alternate content (e.g., ads) before the desired content (e.g., a phone connection between two or more parties). The user is able to select an option to bypass the ads in exchange for a specified value deducted from their available balance.

### Example 12

A user uses a mobile device (e.g., a “smart phone”) to consume content desired by the user (“desired content”). A system hosting the content presents the user with alternate content (e.g., ads) at the same time as desired content. The system offers to allow the user to bypass the ads (e.g., a graphical image and an option to “click”). The user is identified by the system and offers to bypass the ad for a value to be determined on a case-by-case basis.

### Example 13

A content publisher provides web content for view by one or more users. The content publisher enters into contracts with advertisers to present advertising before presenting their video web content. A user views advertising for a fraction of the length of the advertisement (measured in time). The value of the ad space changes as the length of the advertisement remaining changes.

### Example 14

A content publisher provides web content for view by one or more users. The content publisher enters into contracts with advertisers to present advertising before presenting their video web content. A user views advertising for a fraction of the length of the advertisement (measured in time). The value of the ad space is split into two parts. The initial impression is measured and recorded. Any action to bypass the video advertisement is valued at a fixed rate based on various factors, as provided herein (see above).

### Example 15

A content publisher provides web content for view by one or more users. The content publisher enters into contracts with advertisers to present advertising before presenting their video web content. A user views advertising for a fraction of the length of the advertisement (measured in time). The value of the ad space is split into two parts. The initial impression is measured and recorded. Any action to bypass the advertisement is valued at a variable rate based on various factors, as provided herein (see above).

### Example 16

A content publisher provides web content for view by one or more users. The content publisher enters into contracts with advertisers to present advertising before presenting their video web content. A user bypasses advertising content entirely without exposure. Each bypass is recorded in the user's history. This is valued as an impression if the user later views the advertisement in their account.

### Example 17

A content publisher provides web content for view by one or more users. The content publisher enters into contracts with advertisers to present advertising before presenting their video web content. A user bypasses advertising content entirely without exposure. Each bypass is recorded anonymously in the user's history, which can be recorded by the content management system. This is not valued as an impression at any time.

### Example 18

A content publisher provides web content for view by one or more users. The content publisher auctions an available advertising slot and determines an advertiser as the winner of the slot. After this auction the user chooses to pay to bypass the advertisement. The auction is nullified and the advertiser does not owe anything for this advertising slot. The publisher is paid from funds collected from the user. Any value paid by the user that is greater than the value owed to the publisher is kept by the content management system.

### Example 19

A user visits a web site to view content desired by the user (“desired content”). A system hosting the web site presents the user with alternate content (e.g., ads) before the desired content. The system determines that the value to the user for not viewing the alternate content is 5 credits (e.g., something of value) for a specific advertising occurrence. The system provides the user with the option to bypass the alternate content immediately and view the desired content. The user elects the option. The system collects 5 credits from the user or a financial account associated with the user and presents the desired content to the user.

### Example 20

An advertiser works with an advertising agent. The agent uses tools (applications) to optimize an advertising campaign for an advertiser. The agent wins auctions to place advertisements (“ads”) in advertising slots made available by content publishers. A user views the advertisement and an overlay image with an option to bypass the ad for a predetermined price of $0.05. The user chooses to pay the $0.05. The funds are deducted from the user's account on a transaction system facilitating the exchange of an item of value to the user (here, $0.05) in exchange for disabling (or bypassing) an ad. The system then pays the publisher for the value of the advertising slot.

### Example 21

As an alternative to Example 20 above, the user provides 5 credits, which are of value to the user. The value is provided to the publishers as $0.05 or, in some cases, credits that the publishers can use in future transactions or exchange for an item of monetary value, including money. In such a case, the user's account is funded with real money and subsequently revalued as credits.

### Example 22

A system is provided for facilitating the exchange of an item of value to a user in exchange for bypassing an advertisement. The system provides one or more graphical assets to an advertising agent to embed in advertisements. The advertisement agent embeds programmatic hooks into an advertisement to link a graphical asset to the application programming interface (API) of the system. When the user clicks on the graphic (e.g. bypass button), an API call is made to the system to deduct (or exchange) an item of value to the user for bypassing the ad.

Alternatively, the system can provide the one or more graphical assets to the content publisher. The content publisher then makes the API call to the system.

### Example 23

A cookie for tracking user behavior is set on the content publisher's site (e.g., the website) using code embedded by the content publisher so that the cookie is a first-party cookie, rather than a third-party cookie.

Methods and systems provided herein can be combined with or modified by other systems and methods, such as, for example, systems and/or methods provided by U.S. Patent Publication Nos. 2003/0149621 to Shteyn (“ALTERNATIVE ADVERTISING”), 2006/0212442 to Conrad et al. (“METHODS OF PRESENTING AND PROVIDING CONTENT TO A USER”) and 2010/0211464 to Zhu et al. (“TARGETED ONLINE ADVERTISING”), which are entirely incorporated herein by reference.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

1. (canceled)

2. A computer-implemented method for providing advertisements, comprising:
determining, with the aid of a processor, if a user's account balance on an internet fast pass is above a predetermined limit; and
disabling, with the aid of a processor, one or more advertisements if the user's account balance is greater than or equal to the predetermined limit.

3. The computer-implemented method of claim 2, further comprising providing a computer system that implements the internet fast pass, the internet fast pass being associated with the user.

4. The computer-implemented method of claim 2, further comprising reducing the user's account balance by a predetermined amount upon disabling the one or more advertisements.

5. The computer-implemented method of claim 2, wherein disabling the one or more advertisements comprises removing the one or more advertisements from view on a user interface of a computer system of the user.

6.-12. (canceled)

13. A computer-implemented method for altering content presented to a user, comprising:
calculating, with the aid of a processor, the value of a first content to a user, the first content selected in accordance with criteria provided by the user;
presenting the first content to the user in place of the second content; and
collecting an item of value to the user to be presented with the first content, the item of value of equal or greater value than the calculated value of the first content.

14. The computer-implemented method of claim 13, wherein calculating the value of the first content to the user comprises using a computer system to calculate a user-valued estimation of the first content.

15. The computer-implemented method of claim 13, wherein the content presented to the user includes web content, video content, and/or audio content.

16.-17. (canceled)

18. The computer-implemented method of claim 13, wherein the content presented to the user includes one or more of text, image, video and audio.

19. The computer-implemented method of claim 13, wherein the value of the first content is calculated based on the value to the user for not presenting the user with the second content.

20. A computer-implemented method for altering content presented to a user, comprising:
providing a system for presenting a first content and second content to a user, the second content characterized as being less desirable to the user than the first content;
calculating, with the aid of a processor of said system, the value to the user for not presenting the second content to the user; and
presenting the first content to the user in place of the second content.

21. The computer-implemented method of claim 20, further comprising collecting an item of value to the user to be presented with the first content.

22. The computer-implemented method of claim 21, wherein the item of value to the user is equal to the calculated value to the user for not presenting the second content to the user.

23.-37. (canceled)

38. A computer-implemented method for determining the desirability of advertising material to a user, comprising:
enabling, with the aid of a processor, a user to bypass alternate content having advertising material in order to view original content having user-desirable material;
determining whether the user has bypassed the alternate content; and
building the user's viewing preferences.

39. The computer-implemented method of claim 38, wherein building the user's viewing preferences comprises enabling the user to bypass alternate content a plurality of times.

40. The computer-implemented method of claim 38, wherein determining whether the user has bypassed the alternate content comprises determining whether the user has withdrawn money from a bypass account associated with the user.

41. The computer-implemented method of claim 38, wherein determining whether the user has bypassed the alternate content comprises determining whether the user has shared the alternate content.

42.-43. (canceled)
